(19) United States
(12) Patent Application Publication
(10) Pub. No.: US 2022/0075572 A1
(43) Pub. Date: Mar. 10, 2022

(54) PRINTING PARAMETERS

(71) Applicant: Hewlett-Packard Development Company, L.P., Spring, TX (US)

(72) Inventors: Peter Morovic, Sant Cugat del Valles (ES); Hector Gomez Minano, Sant Cugat del Valles (ES); Jan Morovic, London (GB); Sergio Etchebehere Juan, Sant Cugat del Valles (ES); Alessandro Beltrami, Sant Cugat del Valles (ES)

(73) Assignee: Hewlett-Packard Development Company, L.P., Spring, TX (US)

(21) Appl. No.: 17/419,093

(22) PCT Filed: Mar. 7, 2019
(86) PCT No.: PCT/US2019/021212

§ 371 Date: Jun. 28, 2021

(51) Int. Cl. G06F 3/12

(52) U.S. Cl. CPC G06F 3/1208; G06F 3/1284; G06F 3/1237

(57) ABSTRACT

Disclosed is an apparatus generate updated sets of printing parameters for a printing process, the apparatus comprising a processor to receive initial correspondence data indicating correspondence between a plurality of color values and respective sets of printing parameters, wherein at least one colorant combination and a respective coefficient is assigned to each of the sets of printing parameters. The processor is to assign a weight to each colorant combination in the initial correspondence data based on at least a printing quality criterion relating to the colorant combinations within the initial correspondence data, and re-assign colorant combinations and respective coefficients to generate updated sets of printing parameters based on the assigned weights. Also disclosed is a method and a non-transitory computer readable storage medium.

### BACKGROUND

In some printing systems, data for producing printing content may be provided in a particular format. For example, the data in the particular format may include color values in the red, green and blue (RGB) format which is used to represent colors on displays, or in the cyan, magenta, yellow and black (CMYK) format, among others. However, printers may use data indicating printing content represented in a different format which is usable by the printer.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an apparatus to generate updated sets of printing parameters for a printing process;

FIG. 2 is a flow diagram illustrating a first example method of generating updated sets of printing parameters;

FIG. 3 is a sketch of a graph indicating information regarding colorant combinations within initial correspondence data;

FIG. 4a illustrates a first example of a set of printing parameters;

FIG. 4b illustrates a second example of a set of printing parameters; and

FIG. 5 is a flow diagram illustrating a second example method of generating updated sets of printing parameter.

### DETAILED DESCRIPTION

In the following description, for purposes of explanation, numerous specific details of certain examples are set forth. Reference in the specification to “an example” or similar language means that a particular feature, structure, or characteristic described in connection with the example is included in that one example, but not necessarily in other examples.

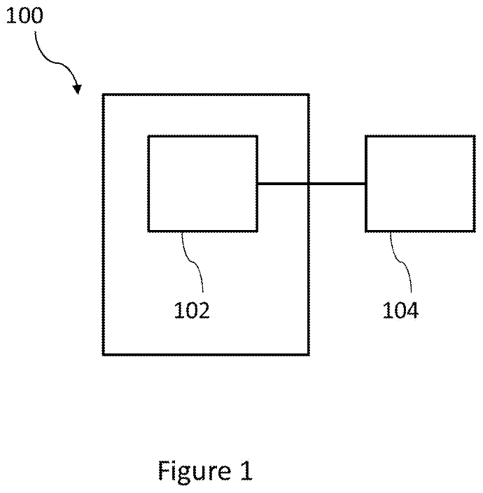

FIG. 1 schematically illustrates an apparatus 100 to generate updated sets of printing parameters for a printing process. The apparatus 100 comprises a processor 102 to receive initial correspondence data indicating correspondence between a plurality of color values and respective sets of printing parameters. In the initial correspondence data, at least one colorant combination and a respective coefficient may be assigned to each of the sets of printing parameters. The processor 102 may assign a weight to each colorant combination in the initial correspondence data based on at least a printing quality criterion relating to the colorant combinations within the initial correspondence data. The processor 102 may re-assign colorant combinations and respective coefficients to generate updated sets of printing parameters based on the assigned weights. Generating update sets of printing parameters may be done by updating each set of printing parameters by modifying its composition based on the assigned weights, as described below.

In this example, the processor is in data communication with a non-transitory computer readable storage medium 104. The non-transitory computer readable storage medium 104 may be a read only memory (ROM) or a read-write memory, for example. The non-transitory computer readable storage medium 104 (hereinafter “storage medium 104”) may be in the form of compact disk (CD), a digital versatile disk (DVD), hard disk drive, solid state drive, a flash memory device and the like.

The storage medium 104 may have instructions stored thereon, which, when executed by a processor (in this instance, the processor 102), causes the processor to perform the above described functions to generated updated sets of printing parameters. The storage medium 104 may store instructions which cause a processor (such as the processor 102) to perform any of the functions described below with respect to the processor 102.

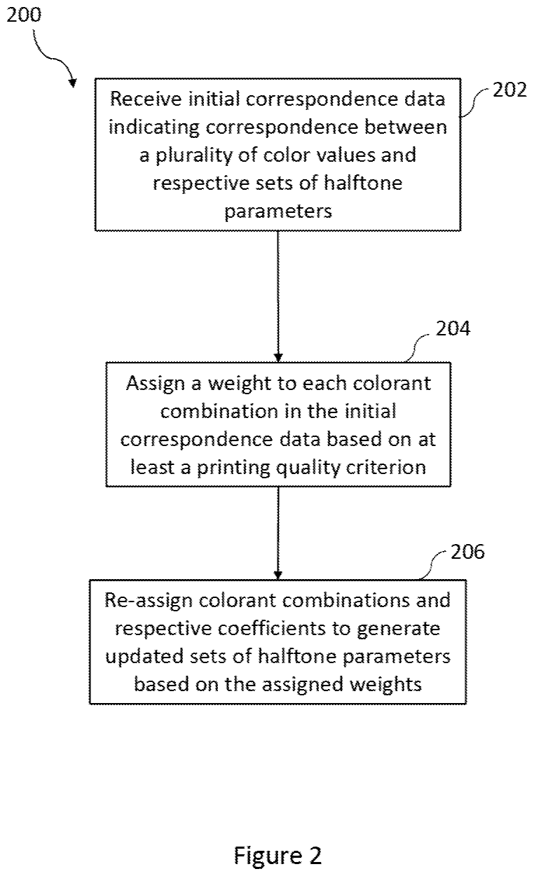

FIG. 2 is a block diagram of a method 200 to generate updated sets of printing parameters for a printing process. The processor 102 may perform the method 200. For example, the processor 102 may perform the method 200 when the instructions stored on the storage medium 104 are executed by the processor 102. At block 202 of the method 200, initial correspondence data indicating correspondence between a plurality of color values and respective sets of printing parameters is received, wherein at least one colorant combination and a respective coefficient is assigned to each of the sets of printing parameters.

A color value may be a coordinate in a color space. In the context of the printing process, the color value may indicate a color to be produced as part of printing content at a given location of a printing target. The printing process may be performed by a printing system. For example, the printing system may be a 2D or 3D printer. Printing data representing the printing content may be sent to the printer for printing. The printing data may be in the RGB format as described above (e.g. the printing data may comprise color values which are RGB values), or the printing data may be in the CMYK format, for example. The color values may be in any format according to a color encoding space, such that the printer can receive the printing data as input. However, printers may use data represented in a format usable by the printer. For example, a printer may not directly use RGB/CMYK values to produce the printing content. Therefore, the RGB/CMYK values may be mapped to data which provides the printer with information about which colorants to dispense and in which combination, etc. (i.e. data which is in a format usable by the printer for printing). This mapping may be performed even in the case where the printing data is in the CMYK format and the printer dispenses CMYK colorants so as to take account of non-linearities, colorant-media interactions and the like. In the following description, the example of color values being RGB values is used for the purpose of explanation.

The data which is usable by the printer may be in the form of sets of printing parameters as referred to above. The sets of printing parameters may also be referred to as printing vectors. The initial correspondence data may indicate a corresponding set of printing parameters for each of the plurality of RGB values. In this way, the initial correspondence data provides a mapping between the RGB values and the sets of printing parameters (i.e. a mapping between printing data in a display device format and printing data in a format usable by the printer). The initial correspondence data may be in the form of an initial look-up table (LUT) relating each RGB (or CMYK, as the case may be) value to its corresponding set of printing parameters. In the following description, the example of the initial correspondence data being in the form of an initial LUT is used for the purpose of explanation.

A colorant combination is a combination of colorants which can be dispensed at a given print location of a printing target by the printer that is to carry out the abovementioned printing process. The term print location may be used to refer to the smallest area where a colorant combination can be dispensed by the printer (e.g. a printing pixel). The printer may dispense a number of colorants such as cyan, magenta, yellow and black (C, M, Y and K) colorants via respective nozzles. In a simple case, the printer may be a bi-level CMYK printer comprising four nozzles, each nozzle arranged to dispense a single amount of one of cyan, magenta, yellow and black colorants (as described herein, the term CMYK printer is used to refer to a printer which dispenses C, M, Y and K colorants). However, the methods/processes described herein may be applied to a printer which dispenses any number of various different colorants (e.g. the methods/processes may be applied to a printer which dispenses C, M, Y, K, light cyan, light magenta, orange, violet and green colorants). For example, a colorant combination may be some combination of no colorant, cyan, magenta, yellow and/or black colorant.

Colorants available to the printer may be in the form of printing material to be dispensed onto a printing target by the printing system. Examples of colorants include inks, dyes, pigments, paints, toners, powders, 3D printing build materials, or the like. The printing target may be paper, card, a fabric, a sheet made of a material suitable for printing (e.g. acetate), or a bed of build material (in the case of 3D printing), for example.

A colorant combination may be represented by a Neugebauer Primary (NP), for example. Each NP specifies a set of respective amounts of colorant to be dispensed, for example, from a set of nozzles of the printer. For example, in the case of a bi-level CMYK printer, one particular NP may specify dispensing a drop of cyan colorant and a drop of black colorant. Each nozzle of a bi-level printer may either dispense no colorant, or a single amount of colorant at a given location. An NP may exist for each combination of colorant amounts and nozzles (including no colorant being dispensed from any of the nozzles).

In a CMYK printer, an NP may be represented by a series of four zeros and/or non-zero integer numbers. The order of the zeros and/or non-zero integer numbers may correspond to the order of the respective colorant colors in the acronym CMYK. Zeros may represent no colorant being dispensed, ones may represent a first amount of colorant being dispensed, twos may represent a second amount of colorant (greater than the first amount—e.g. two drops of ink instead of one) being dispensed, and so on. An NP for a bi-level CMYK printer may include zeros and/or ones. For example, an NP specifying an amount of cyan colorant being dispensed from the cyan nozzle and no colorant being dispensed from any other nozzle may be represented as [1 0 0 0], an NP specifying an amount of magenta colorant from the magenta nozzle and an amount of black colorant from the black nozzle being dispensed may be represented by [0 1 0 1], and so on.

In other examples, the printer may comprise multiple bars, each bar comprising four nozzles, each nozzle arranged to dispense one of cyan, magenta, yellow and black colorant. With respect to a 3-bar printer, an NP may, for example, be represented by a series of 12 zeros and/or ones. In the following description, the example of color combinations being represented by NPs is used for the purpose of explanation.

A result of a printing process which uses printing parameters may be an output in the form of a color separated halftone comprising a halftone plane corresponding to each colorant available to the printing system. Examples of suitable halftoning techniques include error diffusion and parallel random weighted area coverage selection (PARAWACS), for example. A set of printing parameters may represent a statistical distribution of one or more colorant combinations for each print location in the halftone (e.g. a likelihood that a particular colorant combination is to be placed at each printing pixel in the halftone). The sets of printing parameters (i.e. printing vectors) may be represented by Neugebauer Primary area coverage vectors (hereafter referred to as NPacs). An NPac may represent a statistical distribution of one or more NPs over an area of a halftone. For example, an NPac may comprise one or more NPs and corresponding relative area coverage values. The area coverage values may represent probabilities of respective NPs being selected for printing. As such, the area coverage values may be values between 0 and 1. Therefore, in some examples, the colorant combinations assigned to the NPac, as referred to above, may be the NPs comprised in the NPac, and the respective coefficients assigned to the NPac, as referred to above, may be the respective area coverage values.

At block 204, a weight to each colorant combination (NP) in the initial LUT may be assigned based on at least a printing quality criterion relating to the colorant combinations within the initial LUT. As used herein, the term “weight” refers to a parameter which indicates e.g. the importance level/score of the NP to which the weight is assigned. The printing quality criterion may be a criterion which indicates which NPs are to be used in preference to others in order to improve a particular aspect of the quality of the content produced by the printer. For example, the printing quality criterion may relate to overprinting and may indicate that NPs which represent a combination of multiple colorants are to be used as opposed to NPs with fewer colorants, where possible. Assigning NPs to NPacs in this manner may improve printing quality. Another example of a printing quality criterion is a criterion relating to white-minimization, which may indicate that NPs representing the use of a colorant are to be used in preference to NPs indicating that no colorant is to be dispensed, where possible. The weights assigned to each NP may be based on more than one printing quality criterion. In the following description, the example of the printing quality criterion being related to overprinting, as described above, is used for the purpose of explanation.

In some examples, weights assigned based on a printing quality criterion may result in two different NPs being assigned the same weight. For example, the NP [0,1,0,1] may be assigned the same weight as [1,0,0,1] because both of these NPs specify dispensing two colorants. In addition to a printing quality criterion (or multiple printing quality criteria), a weight may be assigned to each NP based on an NP characteristic, relating to the initial LUT, of each of the NPs.

For example, the NP characteristic of the NPs may be the highest area coverage value associated with each NP within the initial LUT. Each NP may be associated with various different area coverage values in the initial LUT. For example, the same NP may be assigned to different NPacs within the initial LUT with different respective area coverage values. In this example, the NP characteristic, relating to the initial LUT, of each given NP may be the highest area coverage value with which that given NP is associated taking into account all the NPacs within the initial LUT. In some examples, other NP characteristics of the NPs, which NP characteristics relate to the initial LUT, may be used in order to assign the weights. For example, the number of times a given NP is specified within the initial LUT may be used. Generally speaking, the NP characteristic used may reflect how and/or to what extent the respective NP is used within the initial LUT.

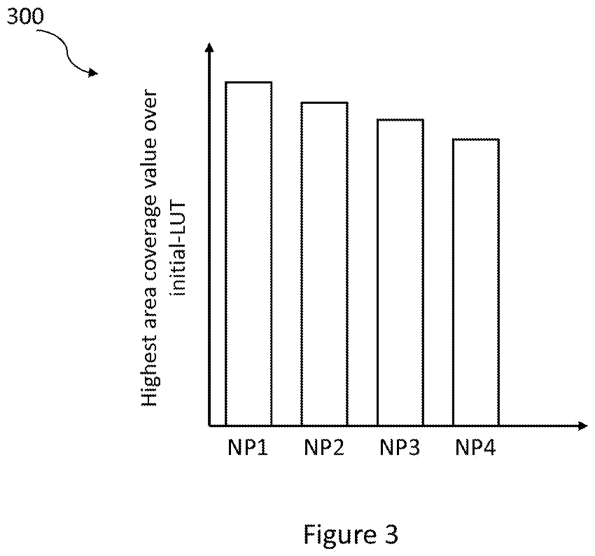

FIG. 3 illustrates a sketch of a graph 300 representing an example NP characteristic of the NPs, which relates to the initial LUT. In this example, the NP characteristic in question is the highest area coverage value with which an NP is associated in the initial LUT and is represented by the vertical axis. The horizontal axis represents the different NPs in the initial LUT. The graph 300 illustrates the highest area coverage value for NPs which may be included in the initial LUT. Although in the illustrated example four NPs are shown, the initial LUT may include a different number of NPs, for example, the initial LUT may include hundreds on NPs (the number of NPs may depend on the printer and the colorants used by the printer). In some examples, each NP in the initial LUT may have a different highest area coverage value. In these examples, weights being assigned to NPs based on the printing quality criterion and this NP characteristic may result in each NP being assigned a unique weight such that different NPs can be distinguished based on their respective assigned weights. Therefore, in some examples, each NP may be assigned a unique weight.

A value for a given NP according to the printing quality criterion may be added to a value for that given NP according to its highest area coverage value within the initial LUT to arrive at a weight for that given NP, for example. The following description refers to an example in which the NP characteristic of the NPs, relating to the initial LUT, is a highest area coverage value within the initial LUT.

At block 206, NPs and respective area coverage values may be re-assigned to generate updated NPacs based on the assigned weights. For example, to generate the updated NPacs, the NPacs present in the initial LUT (hereafter referred to as the initial NPacs) may be updated by re-assigning NPs and respective area coverage values to those initial NPacs according to the assigned weights. It should be noted that each of the initial NPacs is to produce a particular color when the printing content is printed. Therefore, NPs and respective area coverage values may be re-assigned in a manner such that the updated NPacs still produce the same color as the corresponding initial NPacs (such that the color according to the corresponding RGB value is produced).

For example, the re-assigning may involve replacing NPs in a given initial NPac with re-assigned NPs that specify the same colorants as the replaced NPs and have a higher assigned weight than the replaced NPs. The area coverage values may also be re-assigned in a manner such that the updated NPac produces the same color as the corresponding initial NPac. The re-assigning of NPs and area coverage values is described in further detail below.

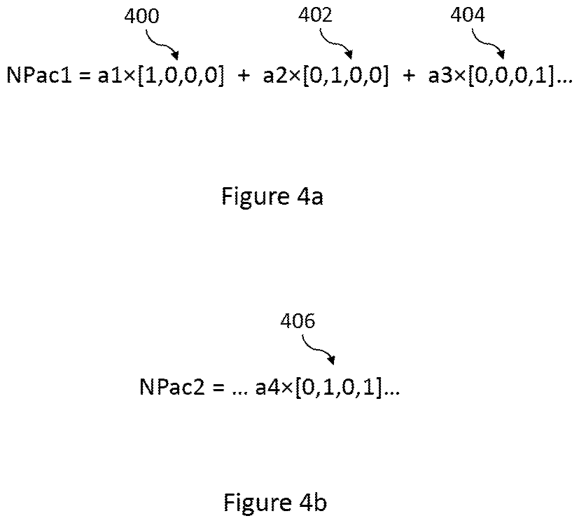

FIG. 4a illustrates a simplified example of an initial NPac and FIG. 4b illustrates a simplified example of a corresponding updated NPac (i.e. after the re-assignment). In this example, the initial NPac is denoted as NPac1, and the updated NPac is denoted as NPac2. As shown, in this example, NPac1 relates to a bi-level CMYK printer where each NP may be represented by a series of 4 zeros and/or ones. NPac1 comprises first, second and third NPs 400, 402 and 404, and respective area coverage values a1, a2 and a3. NPac1 may also comprise other NPs and area coverage values (not shown). The colorants specified by the first, second and third NPs, 400, 402 and 404, are cyan, magenta and black. Each of the first, second and third NPs, 400, 402 and 204, specifies one colorant.

NPs involving cyan, magenta and black colorants which are assigned higher weights may be chosen for NPac2. In the example of FIG. 4b, NPac2 comprises a fourth NP 406, namely the NP specifying [0,1,0,1], (and a respective area coverage value a4) among other NPs which are not shown. The fourth NP 406 may have a higher weight than the first, second or third NPs, 400, 402 and 404, due to the fourth NP 406 specifying two colorants instead of one.

It should be noted that an NP specifying cyan and black colorants, i.e. [1,0,0,1] could also be used. The fourth NP 406 may be assigned a higher weight than the NP specifying [1,0,0,1] due to the fourth NP 406 having a higher highest area coverage value in the initial LUT than the highest area coverage value for the NP specifying [1,0,0,1] in the initial LUT. Therefore, NPac2 may be re-assigned a combination of NPs including [0,1,0,1] instead of a combination including [1,0,0,1]. One NP may be selected over another in this manner. However, it should be noted that this is a simplified example for the purpose of explanation. Practically speaking, an updated NPac may be re-assigned NPs such that the total weight of the re-assigned NPs in the updated NPac is highest out of the possible combinations of NPs that could be re-assigned to the updated NPac (e.g. based on the colorants involved).

The area coverage values may be re-assigned such that the updated NPac specifies the same overall probability of each colorant being dispensed as the corresponding initial NPac (so that the desired color is produced using the updated NPac). For example, if a given initial NPac comprises: 0.5×[1,0,0,0], indicating a 50% chance of cyan colorant being dispensed, the corresponding updated NPac may be re-assigned NPs and respective area coverage values such that there remains a 50% chance of cyan colorant being dispensed. For example, the updated NPac may, inter alia, comprise: 0.5×[1,1,0,0] provided magenta is also a colorant specified by the given initial NPac with at least a 50% chance of being dispensed. In this manner, updated NPacs may be generated.

In some examples, when the NPs and area coverage values are being re-assigned to generate updated NPacs, NPs with lower weights in a given initial NPac may be replaced by NPs with higher weights. In some examples, NPs may be removed altogether based on the relative weights of the relevant NPs, and the area coverage values of the remaining NP may be adjusted such that each colorant in the updated NPac has the same probability of being dispensed as in the initial NPac. For example, if a given initial NPac comprises the NPs: [1,0,0,0], [0,1,0,0] and [1,1,0,0], the one or both of the NPs using one colorant may be removed depending on whether the area coverage values of the remaining NPs can be adjusting in a manner such that the overall probability of each colorant being dispensed remains the same.

In some examples, one or more additional criterion may be applied in the generation of the updated NPacs. The additional criterion may relate to, for example, a total number of NPs in all of the updated NPac, the complexity of each individual updated NPac (e.g. total number of NPs within each NPac), or another additional criterion which may reduce the processing burden, may conform to certain limits (e.g. a colorant combination limit as discussed further below), may provide an image quality improvement, and the like.

The processor 102 may generate updated correspondence data using the updated NPacs. The updated correspondence data may indicate a correspondence between the RGB values and the updated NPacs. For example, the updated correspondence data may indicate an updated NPac for each of the RGB values that were in the initial LUT. The updated correspondence data may be in the form of an updated LUT. The initial LUT may be updated by replacing the initial NPacs with their corresponding updated NPacs to generate the updated LUT. The updated LUT may be used for printing by convert printing data e.g. from the RGB format to a format usable by the printer.

As a result of NPs and respective area coverage values being re-assigned taking account of the printing quality criterion (via the assigned weights being based on the printing quality criterion), the quality of the content produced according to the updated NPacs may be improved as compared to the initial NPacs. In addition, the assigned weights also being based on an NP characteristic of the NPs relating to the initial LUT may allow unique weights to be assigned to each NP, as discussed above. Re-assigning NPs and respective area coverage values may result in a reduction in the total number of NPs in the updated NPacs as compared to the initial NPacs (this may be the case irrespective of the one or more additional criterion referred to above).

It should be noted that an area coverage value represents the probability of its respective NP being selected for printing. Therefore, NPs which are associated with higher area coverage values in the initial LUT are more likely to be printed. By assigning weights to the NPs, at least in part, based on their highest area coverage value in the initial LUT, this character of the initial LUT may be maintained. This is because, NPs with a higher value for the highest area coverage value may be more likely to be re-assigned to updated NPacs. The initial LUT may have been generated based on printing quality considerations, and certain NPs may be associated with higher area coverage values in view of these considerations. Generating the updated NPacs by assigning weights based at least in part on respective highest area coverage values in the initial LUT may result in the NPs associated with higher values for the highest area coverage value being more likely to be assigned to the updated NPacs. Therefore, the printing quality considerations may be maintained when NPs are re-assigned to the updated NPacs.

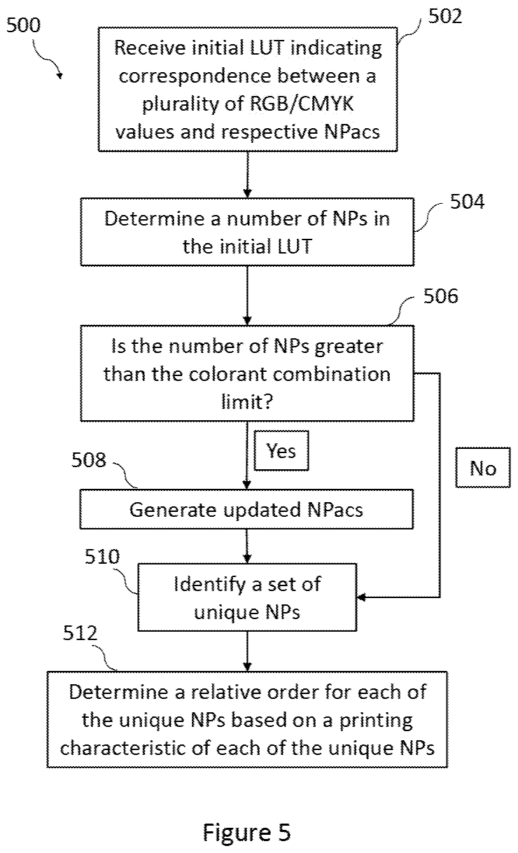

FIG. 5 is a block diagram of a method 500. The method 500 may be performed by the processor 102. For example, the storage medium 104 may store instructions, which, when executed by the processor 102, cause the processor 102 to perform the method 500. Blocks 502 in FIG. 5 may correspond to block 202, and block 508 in FIG. 5 may correspond to block 204 and 206 in FIG. 2. The blocks in FIG. 5 which correspond to blocks in FIG. 2 may include the same or similar features as described above.

At block 502, an initial LUT indicating correspondence between a plurality of RGB values (or CMYK values, for example) and respective NPacs is received, wherein at least one NP and a respective area coverage value is assigned to each of the NPacs. At block 504, a number of NPs in the initial LUT is determined. At block 506, the number of NPs is compared to a colorant combination limit. In examples where the colorant combinations are represented by NPs, the colorant combination limit may be an NP limit.

The printer may use correspondence data such as, for example, the initial or updated LUTs to map RGB values indicated by printing data to NPacs for printing. However, the printer may have a limit on the number of NPs with respect to which the printer can process data. For example, the printer may not be able to use a LUT in which the total number of NPs is above the printer's NP limit. The printer's NP limit may define the maximum number of NPs the printer can process. The printer's NP limit may relate to its processing capacity (e.g. based on the hardware included in the printer). Therefore, the described methods may be performed in order to reduce the number of NPs in the initial LUT. As described above, the number of NPs may be reduced when NPs and respective area coverage values are re-assigned to generate the updated NPacs.

Therefore, updated NPacs may be generated when the initial LUT comprises a number of NPs greater than the NP limit of the printer in question (i.e. the printer in respect of which the methods described herein are being carried out). In some examples, updated NPacs may not be generated if the initial LUT comprises a number of NPs less than the NP limit. In other examples, blocks 504 and/or 506 may be omitted so that updated NPacs are generated irrespective of the number of NPs.

If the determined number of NPs is less than or equal to the NP limit, the method 500 proceeds to block 510. On the other hand, if the determined number of NPs (the number of NPs in the initial LUT) is greater than the NP limit, the method 500 proceeds to block 508. At block 508, the updated NPacs are generated. For example, the updated NPacs may be generated as described above in relation to the method 200. Block 508 may therefore correspond to blocks 204 and 206 of the method 200.

At block 510, a set of unique NPs are identified based on the NPacs. The set of unique NPs indicates all the unique NPs that are present in the NPacs. In the example of method 500, the updated NPacs are generated before the set of unique NPs is identified (i.e. the processor 102 may identify the set of unique NPs based on the updated NPacs). In such examples, the set of unique NPs may be identified based on the updated NPacs. Identifying the unique set of NPs based on the updated NPacs may involve a lesser processing burden than identifying the unique set of NPs based on the initial NPacs from the initial LUT. This is because the updated NPacs may have fewer NPs in total than are present in the initial LUT. Therefore, there may be fewer NPs to process if the updated NPacs are used.

At block 512, a relative order for each of the unique NPs in the set of unique NPs is determined based on a printing characteristic of each of the unique NPs. The printing characteristic may be a characteristic related to the visual appearance of the printing content produced according to the NP in question. One example of a printing characteristic is lightness. In the example of a CMYK printer printing on white paper, an NP may produce printing content that has a lightness inclusively between the white of the paper and the blackest color that can be produced given the colorants used by that printer. In examples where the printing characteristic is lightness, the unique NPs may be ordered in terms of lightness, e.g. from light to dark.

In other examples, the order of the blocks in the method 500 may be changed such that blocks 510 and 512 are performed before one or more of blocks 504 to 508. In such examples, the set of unique NPs may be identified based on the initial NPacs.

To order the unique NPs, all the unique NPs may be printed using the same area coverage value as one another. A common area coverage value may be used so that lightness of the unique NPs is not related to the total quantity of colorant dispensed, but on the unique NPs themselves (i.e. so that the lightness can be determined based on the colorant combination in question as oppose to other factors which may affect lightness). The common area coverage value may be selected in consideration of any limits the printer may have (e.g. the printer may have a limit to how much colorant may be dispensed at each print location).

In some examples, the processor 102 may generate a chart, which uses all the unique NPs with the common area coverage value, for printing. The generated chart may be printed and the lightness of each unique NP measured. The generated chart may be measured using a suitable measuring device, for example, a spectrophotometer, a densitometer, a colorimeter, and RGB camera, or the like. The processor 102 may subsequently receive data indicating the measured lightness of each unique NP.

The processor 102 may determine the relative lightness of the unique NPs based on the received data indicating the measured lightness of each unique NP. An order for the unique NPs may be determined based on the relative lightness. Such ordering may be determined for all the printing targets which the printer may print on and/or all print-modes of the printer, for example, by performing the above described process. In some examples, the process of printing and measuring a chart of the unique NPs may not be performed. This may be the case if the printing and measuring takes up a lot of time and resource.

In some examples, previous measurements of e.g. a super-set of NPs (e.g. all possible NPs according to which the printer can dispense colorants) may be used in order to approximate the relative lightness order of the unique NPs.

Data relating to the determined order (e.g. determined lightness order) may be included in the updated LUT. The order may be used in combination with a halftone matrix for printing, as described below. For producing a patch of a given color, the spatial distribution of the NPs in the NPac corresponding to the given color (i.e. the spatial distribution over the patch) is determined based on the respective area coverage values (e.g. probabilities) associated with the NPs in that NPac. For example, if a patch of the given color is to be produced, an NP may be assigned to each print location of the patch according to the probability indicated by its associated area coverage value.

The halftone matrix allows the selection of an NP for printing at a given print location based on the probabilities (e.g. area coverage values) specified by the NPac corresponding to the color to be printed at the given print location. The role of the halftone matrix is to spatially distribute NPs based on the probabilities specified by the respective NPacs at the different print locations. As mentioned above, an output of the printer, in a halftone printing process, is in the form of a color separated halftone comprising a halftone plane corresponding to each available colorant. The halftone matrix may be used to specify which colorants are dispensed at which print location and in which order to produce the printing content according to the particular halftone being used.

In some examples, the halftone matrix may be generated by the apparatus 100. The values of the halftone matrix may be uniformly distributed and each value may have an equal probability of occurring. The halftone matrix may be used to generate a halftone image. The halftone image may be a representation of the printing content. The printer may generate the halftone image using the halftone matrix. The halftone matrix may be saved in a computer readable storage medium of the printer, for example. The halftone matrix may be supplied to the printer along with information about how the halftone matrix was built (e.g. whether the halftone matrix was populated with lower values first). In examples where data relating to the determined order is also available in the updated LUT, the printer may use the halftone matrix, the information about how the halftone matrix was built, and the determined order to generate the halftone image. Taking account of the determined order in combination with information about how the halftone matrix was built when generating the halftone image may improve the quality of the halftone image. This may improve printing quality when the printer produces content according to the halftone image. Improved quality of the halftone image may occur where halftoning techniques such as error diffusion and PARAWACS are used, for example.

The processor 102 may receive the initial correspondence data from the storage medium 104, or another computer readable storage medium comprised in the printer, on which the initial correspondence data is stored. In some examples, the processor 102 may determine the initial correspondence data (e.g. the initial LUT). In such examples, the processor 102 may receive the initial correspondence data from a working memory such as a rapid access memory (RAM) in data communication with the processor 102. The initial correspondence data may be determined as part of methods 200 and/or 500 described above. An example process for determining the initial correspondence data is described below.

The processor 102 may determine the initial correspondence data by mapping each color value (e.g. RGB value) to be included in the initial correspondence data to a set of printing parameters (e.g. NPacs), as described below. In order to do this, a mapping image file may be created which indicates patches of constant color (i.e. patches of color corresponding to a single color value). The patches may correspond to color values intended to be included in the initial correspondence data.

A halftone creation process may be performed on the mapping image file to generate halftone printing data in a format usable by the printer. The halftone creation process may be a prior art process for converting printing data into a format usable by the printer. For example, the halftone printing data may indicate which colorants to dispense in which quantity at all the print locations of the mapping image. The halftone printing data may not be used to print the mapping image, but may instead be intercepted for the purpose of generating the initial correspondence data.

The halftone printing data may be parsed into the patches of constant color, and the different colorant combinations within each patch may be identified. It should be noted that each of these colorant combinations may be represented as a different NP. In this way, the different NPs involved in printing each patch of constant color may be identified. For each of the patches of constant color, the frequency of all colorant combinations may be counted. Counting the frequency of a given colorant combination may correspond to counting the number of print locations within the relevant patch at which the halftone printing data indicates dispensing the given colorant combination. The frequency of each colorant combination may be normalized by the total number of print locations in the relevant patch of constant color (i.e. the number of print locations at which a given colorant combination is to be dispensed may be divided by the total number of print locations of the relevant patch). The normalized frequency may correspond to an area coverage value for its respective colorant combination.

In this way, for each given patch of constant color, and therefore for each given color value intended to be included in the initial correspondence data, the relevant NPs and respective area coverage values may be determined. These NPs and respective area coverage values for each given patch of constant color may be assigned to an NPac. In this way, an NPac may be determined for each given color value. The initial correspondence data may be generated which indicates correspondence between a plurality of color values and respective NPacs.

Some or all of the above described methods/processes may be performed by the printer (e.g. by a processor of the printer). For example, the apparatus 100 may be part of the printer. In the examples which include measuring the generated chart after printing to determine an order of the unique NPs, the printer may comprise the measuring device. In other examples relating to measuring the generated chart after printing, the printer may not comprise the measuring device and the measurements may be performed at a separate apparatus. In these examples, the relevant processor of the printer may receive the measured lightness of each NP for further processing as described above.

In some examples, the apparatus 100 may be remote from the printer. In these examples, where any printing content is to be produced as part of the above described methods/processes, the relevant data may be received by the printer to print the printing content in question. The updated correspondence data may be provided to the printer for use during printing processes. For example, the updated correspondence data may be supplied in the form of data stored on computer readable memory device such as a compact disk (CD), a digital versatile disk (DVD), hard disk drive, solid state drive, a flash memory device and the like. The initial correspondence data may be transferred to a computer readable storage medium of the printer. Alternative, the computer readable memory device may be supplied for installation into the printer.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus to generate updated sets of printing parameters for a printing process, the apparatus comprising a processor to:
receive initial correspondence data indicating correspondence between a plurality of color values and respective sets of printing parameters, wherein at least one colorant combination and a respective coefficient is assigned to each of the sets of printing parameters;
assign a weight to each colorant combination in the initial correspondence data based on at least a printing quality criterion relating to the colorant combinations within the initial correspondence data; and
re-assign colorant combinations and respective coefficients to generate updated sets of printing parameters based on the assigned weights.

2. The apparatus according to claim 1, wherein a weight is assigned to each colorant combination based on a colorant combination characteristic, relating to the initial correspondence data, of each of the colorant combinations.

3. The apparatus according to claim 2, wherein the colorant combination characteristic of the colorant combinations is the highest area coverage value associated with each colorant combination within the initial correspondence data.

4. The apparatus according to claim 3, wherein each colorant combination is assigned a unique weight.

5. The apparatus according to claim 1, wherein:
the colorant combinations are represented by Neugebauer Primaries;
the sets of printing parameters are represented by Neugebauer Primary area coverage vectors.

6. The apparatus according to claim 1, wherein the processor is to generate updated printing parameters in response to a determination that a number of colorant combinations in the initial correspondence data is greater than a predetermined colorant combination limit.

7. The apparatus according to claim 1, wherein the processor is to:
identify a set of unique colorant combinations based on the sets of printing parameters;
determine a relative order for each of the unique colorant combinations in the set of unique colorant combinations based on a printing characteristic of each of the unique colorant combinations.

8. The apparatus according to claim 7, wherein the processor is to identify the set of unique colorant combinations based on the updated sets of printing parameters.

9. The apparatus according to claim 7, wherein the processor is to generate updated correspondence data using the updated sets of printing parameters and the determined relative order.

10. A non-transitory computer readable storage medium having instructions stored thereon, which, when executed by a processor, cause the processor to generate updated sets of printing parameters for a printing process, by causing the processor to:
receive initial correspondence data indicating correspondence between a plurality of color values and respective sets of printing parameters, wherein at least one colorant combination and a respective coefficient is assigned to each of the sets of printing parameters;
assign a weight to each colorant combination in the initial correspondence data based on at least a printing quality criterion relating to the colorant combinations within the initial correspondence data; and
re-assign colorant combinations and respective coefficients to generate updated sets of printing parameters based on the assigned weights.

11. The non-transitory computer readable storage medium according to claim 10, wherein the instructions stored on the non-transitory computer readable storage medium, when executed by the processor, cause the processor to:
determine a number of colorant combinations in the initial correspondence data;
compare the number of colorant combinations to a colorant combination limit; and
generate updated sets of printing parameters if the number of colorant combinations in the initial correspondence data is greater than the colorant combination limit.

12. The non-transitory computer readable storage medium according to claim 10, wherein the instructions stored on the non-transitory computer readable storage medium, when executed by the processor, cause the processor to:
identify a set of unique colorant combinations based on the sets of printing parameters; and
determine a relative order for each of the unique colorant combinations in the set of unique colorant combinations based on a printing characteristic of each of the unique colorant combinations.

13. The non-transitory computer readable storage medium according to claim 12, wherein the instructions stored on the non-transitory computer readable storage medium, when executed by the processor, cause the processor to:
generate updated sets of printing parameters before identifying the set of unique colorant combinations; and
identify the set of unique colorant combinations based on the updated sets of printing parameters.

14. The non-transitory computer readable storage medium according to claim 10, wherein the updated sets of printing parameters comprise fewer colorant combinations in total than are present in the initial correspondence data.

15. A method to update sets of printing parameters for a printing process, the method comprising:
acquiring correspondence data indicating correspondence between a plurality of coordinates in a color space and respective printing vectors, wherein each printing vector comprises at least one colorant combination and a respective coefficient;
assigning a weight to each colorant combination in the correspondence data based on at least one printing quality criterion and a colorant combination characteristic of each of the colorant combinations with respect to the correspondence data; and
updating each printing vector by modifying its composition based on the assigned weights.
